(19) United States
(12) Patent Application Publication
(10) Pub. No.: US 2005/0071137 A1
(43) Pub. Date: Mar. 31, 2005

(54) Model-centric method and apparatus for dynamic simulation, estimation and optimization

(75) Inventors: Ramasamy Selvaraj, Solon, OH (US); Xiangming Hua, Willoughby, OH (US); Todd Hess, Chagrin Falls, OH (US)

Correspondence Address: Michael M. Rickin, Esq.;ABB Inc., Legal Department - 4U6, 29801 Euclid Avenue, Wickliffe, OH, 44092-2530, US

(73) Assignee: ABB Inc.

(21) Appl. No.: 10/675,727

(22) Filed: Sep. 30, 2003

(51) Int. Cl. G05B 13/02; G06G 7/48

(52) U.S. Cl. 703/6

(57) ABSTRACT

A framework which allows a user to build a general purpose process flowsheet that represents a model of a process and by an interpreter generates from the flowsheet the model which can be used to execute applications selected from simulation, estimation and optimization. The framework includes various editors including a flowsheet editor and simulation, estimation and optimization activity editors. The framework also includes a task scheduler which commands simulation, estimation and optimization input generators to collect information from the flowsheet database and model library files and present them to the solution engine for solving the system of flowsheet models and equations. The single process model can be used in a number of on-line and off-line applications and the applications may be either dynamic or steady state. The process may be a batch process or a continuous process or any other kind of process.

### 1. FIELD OF THE INVENTION

This invention relates to dynamic process modeling and more particularly to dynamic simulation, estimation and optimization of industrial processes with a flexible model development framework.

### 2. DESCRIPTION OF THE PRIOR ART

Facing economic, environmental and safety constraints, industries are forced to improve performance of their plants and to reduce the cost and time for plant development. As reported by Marquardt, W. (1991), “Dynamic process simulation—recent trends and future challenges” in Arkun, Y. and W. H. Ray, (Eds.) Chemical Process Control CPC-IV CAChE, Austin, AIChE, New York, p131-180; and Pantelides, C. C. and P. I. Barton (1993). “Equation oriented dynamic simulation: Current status and future perspectives”, Computer and Chemical Engineering, 17S, p263-285, system simulation, estimation and optimization have become vital tools in order to achieve these goals and to be competitive in a rapidly growing market with increasingly short innovation cycles.

For example, consider the pulp and paper industry where continuous pulping processes have, as is described by Gullichen, J., and C.-J. Fogelboln (2000), Chemical Pulping, Gummerus Printing, Jyraeskylae, Finland, grown to dominate the production of kraft pulp. The digester is the heart in a pulp and paper mill, and its operation directly impacts the economic benefit of the plant and the quality of the final paper product. Therefore, the digester has attracted much attention in model development and advanced control etc. due to its critical importance and high capital investment. See Wisnewski, P. A., F. J. Doyle III, and F. Kayihan (1997), “Fundamental continuous pulp digester model for simulation and control”, AIChE J., 43(12), p3175-3192; and Dahlquist, E. et al. (2001), “Economic benefits of advanced digester control”, Pulp Digester Modeling and Control Workshop, Jun. 28, 2001, Annapolis, Md., USA.

While simulation techniques have been commonly used in the process industries such as the petrochemical industry for several decades, there still are many challenging issues to be solved. In particular, the pulp and paper industry has had much less applications of this technology to date. A few steady-state process simulation packages are available for the pulp and paper industry, but these are sequential modular simulators and are customized for specific needs in the industry.

Although some extensions to dynamic simulation of the pulping process using one of these packages have been made [see Shewchuk, C. F. (1987), “Massbal mkII: New process simulation system”, Pulp & Paper Canada, 88(5), p76-82], the pulp and paper industry still lacks a dynamic modeling system with rigorous process modules, especially for a digester. On the other hand, interest is increasing in efficient dynamic simulation systems integrated with advanced application tools like simulation, estimation and optimization for that industry.

In any chemical process industry, there is a constant drive to maximize throughput, minimize product quality fluctuations, etc. amidst constant demand for varied product grades. In such a situation increased understanding of the underlying process and enhanced knowledge of the operations becomes extremely important. Unfortunately, due to the nature of the operations and equipment, it is not always possible to access all sections of the process vessels.

For example, in the digester where the cellulose fibers are separated from lignin, the wood chips are steamed and fed with cooking chemicals in the form of alkali with very long residence times (about 6 to 8 hours). It is important to know the amount and extent of reaction inside the digester at various points, so that the side draws can be manipulated to attain the operational targets. However it is very difficult or even impossible to obtain accurate measurements inside the digester. The current practice is to take samples at the side draws and analyze them with online analyzers or lab experiments. Lab results are time consuming and not available frequently. Online analyzers based on side draws provide continuous measurements but provide only local measurements and do not provide information inside the digesters. Moreover they are susceptible to error or even failure and may require high maintenance.

In general, many engineering applications such as process design, simulation, estimation, and optimization in the chemical process industries have been implemented separately with different software. These applications rely on the presence of a good mathematical model, but the models used may be developed from different sources in spite of the same process. These approaches result in increased project engineering costs due to redundant effort as there is little or no model reuse and design changes are not easily translated across all models.

The success of the model-based applications depends largely on the approximation accuracy of the dynamic model. Usually a rigorous model is preferred, which must represent complex physical phenomena within this process including both chemical reactions and transport phenomena such as bulk flow, convection and diffusion. However these models are often very large and complex, involving thousands of nonlinear algebraic and differential equations. For example, in the pulping process described above, the digester is a tubular multiphase vertical reactor operating in plug flow with varying directional flows of liquor throughout the vessel, and presents quite some challenges for process model development. Various configurations of digesters also exist within the industry.

It would be desirable for a flowsheet simulator to have the ability to handle these different types and geometries of operation. This also means that a flexible and efficient model development framework for simulation and other model-based solutions is required. The present invention meets these requirements as it presents a framework that allows a process flowsheet to be built for dynamic simulation, estimation and optimization based on a model-centric methodology.

### SUMMARY OF THE INVENTION

A method associated with a process. The method comprises building a general purpose flowsheet for the process. The general purpose flowsheet representing a model of the process. The method also comprises generating the model of the process from the general purpose flowsheet. The method further comprises executing upon the model generated from the general purpose flowsheet applications selected from simulation, estimation and optimization.

A computer readable medium having instructions associated with a process. The instructions comprise building a general purpose flowsheet for the process. The general purpose flowsheet representing a model of the process. The method also comprises generating the model of the process from the general purpose flowsheet. The method further comprises executing applications selected from simulation, estimation or optimization upon the model generated from the general purpose flowsheet.

A method for enabling a user to build a general purpose process flowsheet whose underlying model may be used to execute applications selected from simulation, estimation and optimization. The method comprises enabling the user to build the general purpose process flowsheet by providing a graphical flowsheet builder; a library of common equipment models; selectable chemical species and their thermophysical property definitions; and stream connectors to allow the user to connect models selected from the library. The method also comprises providing an interpreter to generate the underlying model from the general purpose flowsheet. The method further comprises providing a solution engine that enables the user to use the generated underlying model in applications selected from simulation, estimation and optimization.

A method for enabling a user to build a general purpose process flowsheet whose underlying model may be used to execute applications selected from simulation, estimation and optimization. The method comprises enabling the user to build the general purpose process flowsheet by providing a graphical flowsheet builder; a library of common equipment models; selectable chemical species and their thermophysical property definitions; and stream connectors to enable the user to connect models selected from the library. The method also comprises providing an interpreter to generate the underlying model from the general purpose flowsheet. The method further comprises providing a solution engine that allows applications selected from simulation, estimation or optimization to be executed upon the generated underlying model.

An apparatus for building a general purpose flowsheet having an underlying model for a process. The apparatus comprises a library of selectable common equipment models. The apparatus also comprises a repository of selectable chemical species and their thermophysical property definitions. The apparatus further comprises a flowsheet editor for selecting one or more of the selectable common equipment models and one or more of the selectable chemical species and thermophysical properties definitions associated with the one or more selected models and linking the one or more selected models by stream connectors to build the general purpose flowsheet. The apparatus also further comprises an interpreter to generate the underlying model from the general purpose flowsheet; and a solution engine for executing applications selected from simulation, estimation or optimization upon the generated underlying model.

### DESCRIPTION OF THE DRAWING

FIG. 1 shows a simplified schematic of an industrial pulping process.

FIG. 2 shows the configuration architecture for the modeling framework or model development framework described herein.

FIG. 3 shows the execution architecture for the modeling framework or model development framework described herein.

FIG. 4 shows a screen shot for and FIG. 4a shows in detail the equivalent representation of the pulp digester as a flowsheet in the model development system and framework described in this embodiment.

FIG. 5 shows in an investigation of the dynamic behavior of the model developed in accordance with the present invention the movement of the Kappa number profile after a predetermined step increase of the chip screw while keeping all other process variables unchanged.

FIG. 6 shows a comparison of the bottom Kappa number between the prediction of the model developed in accordance with the present invention and measurement over a day.

FIG. 7 shows based on the model developed in accordance with the present invention the prediction of the moisture in the chip feed entering the digester.

### DESCRIPTION OF THE PREFERRED EMBODIMENT(S)

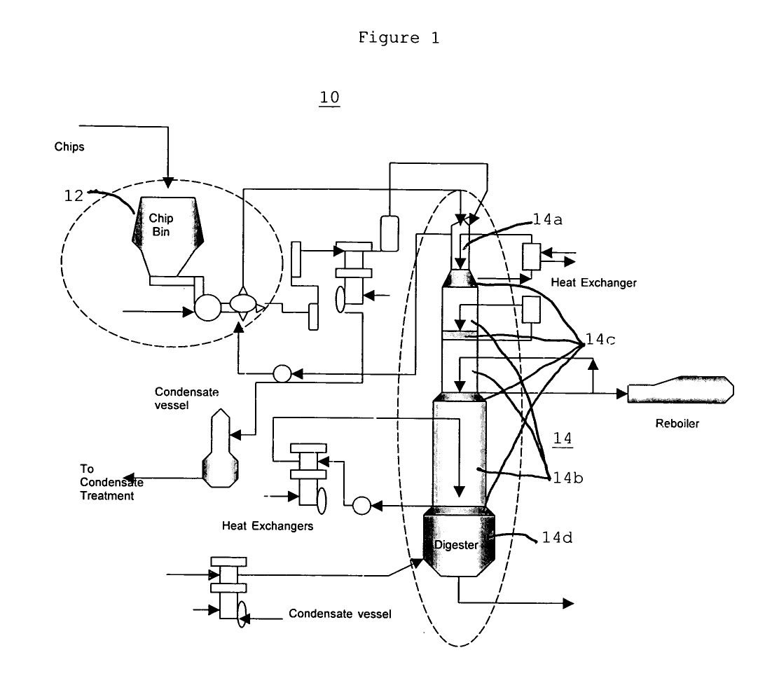

The present invention is described below using the pulp digester, a simplified schematic for which is shown in FIG. 1, as an application case. It should, however, be appreciated that the model-centric methodology of the present invention may be used to dynamically simulate, estimate and optimize other processes.

As is shown in FIG. 1, and as is well known to those in the art, in the pulping process 10 wood chips are mixed with steam in the chip bin 12 and are cooked in the digester 14 to separate the lignin from the cellulose fibers to form pulp. Digester 14 can in accordance with the present invention and as is described in more detail below be represented using four process modules, namely, top separator 14a, digester sections 14b, screens 14c and bottom scraper 14d.

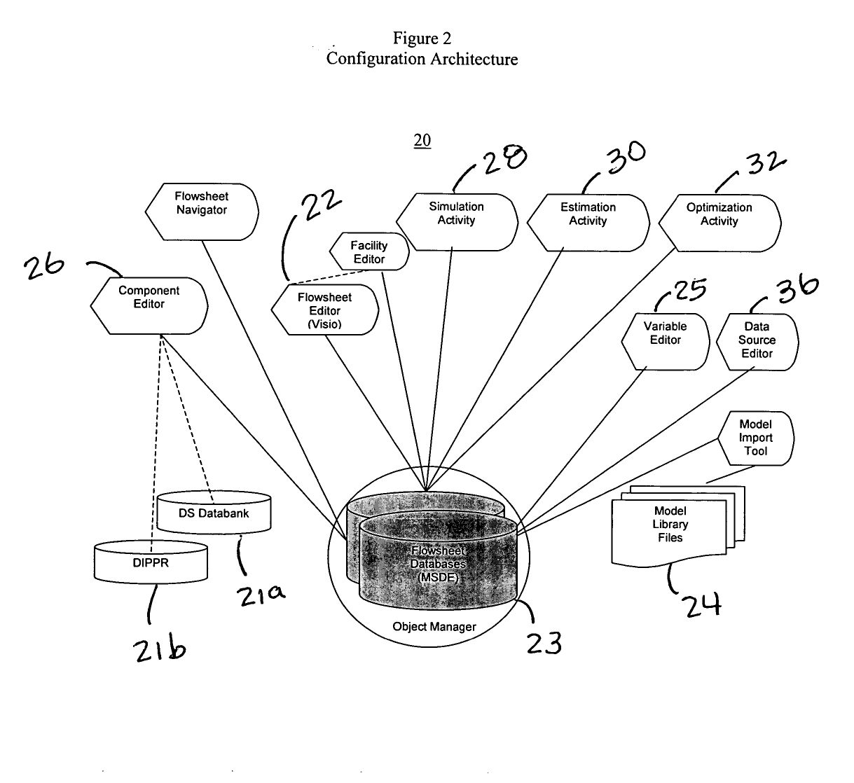

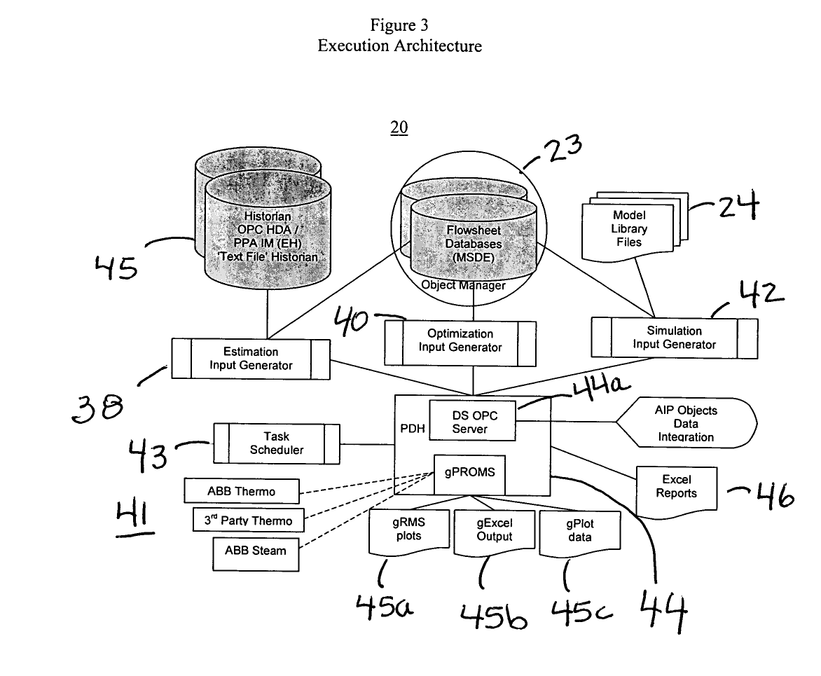

The present invention is described in connection with a modeling framework (or a model development framework), the configuration architecture for which is shown in FIG. 2 and the execution architecture for which is shown in FIG. 3, that supports graphical user interfaces enabling component configuration and editing, graphical process flowsheeting, model specifications, steady state/dynamic simulation configuration, and integration with estimation and optimization applications.

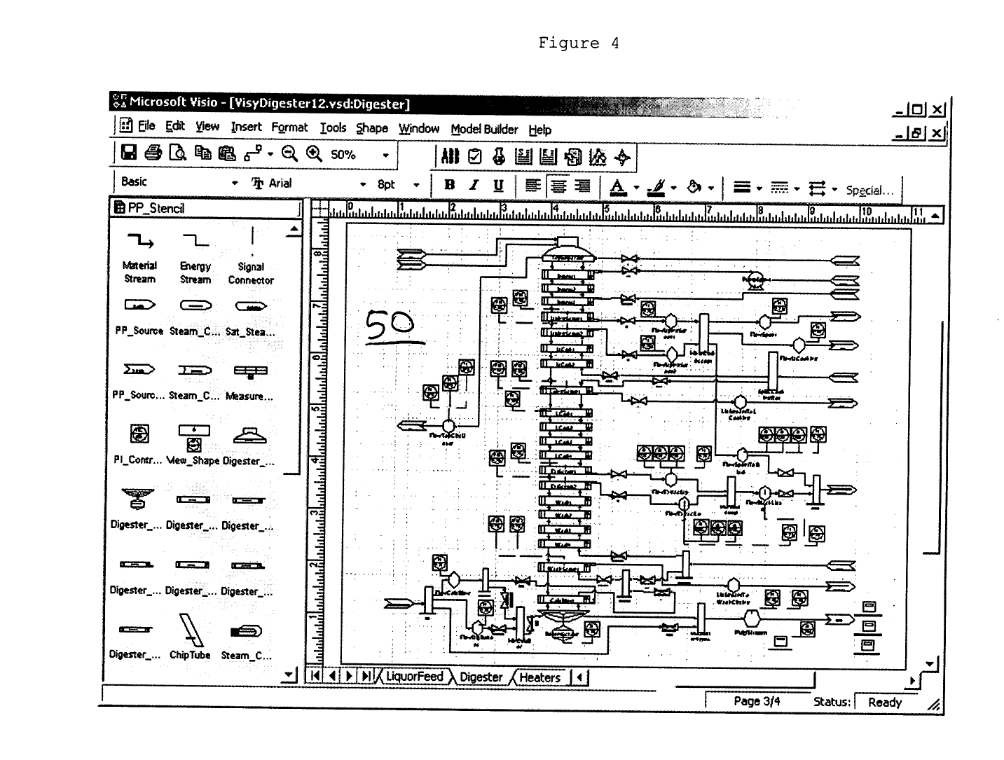

The framework 20 of FIGS. 2 and 3 allows a user to build a process flowsheet, such as the flowsheet shown in FIGS. 4 and 4a which shows the digester section model 50 of pulping process 10, for simulation of industrial processes, and use this same flowsheet in a variety of applications such as inferential property calculations, parameter estimation, data reconciliation, optimization, etc. It provides an easy to use graphical flowsheet builder (editor), a library of common equipment models, and flexible interfaces for configuring activities or applications.

As is shown in the configuration architecture of FIG. 2, a process flowsheet such as the flowsheet shown in FIGS. 4 and 4a, is built using the ‘flowsheet editor’ 22 by dragging and dropping equipment shapes in the form of icons in flowsheet editor stencils representing mathematical models from the model library 24 and connecting these shapes by stream connectors. Streams are composed of the different chemical components configured using the ‘component editor’ 26. Editor 26 can link to a framework-provided properties databank 21a or has an interface to other commercially available property packages such as DIPPR (21b) to obtain chemical component property information. The component editor 26 is also used to specify the thermodynamic package 41 (see FIG. 3) used for calculating thermodynamic properties. Simulation, estimation, and optimization activities are configured using the corresponding ‘activity editors’ 28, 30 and, 32, respectively. All configuration information using the various editors are persisted in the Flowsheet Databases 23 of FIGS. 2 and 3.

The task scheduler 43 of FIG. 3 commands the estimation, optimization and simulation ‘input generators’ 38, 40, 42, respectively of FIG. 3, to collect all necessary information from the persisted storage (flowsheet database and model library files) and submit them to the solution engine 44 for solving the resulting system of flowsheet models and equations. When operating data is required for example in estimation activities either to tune the models or to update the model parameters periodically, an interface to the historian available with the framework can link to the plant historian 45 to fetch required data. Such data connectivity for model variables from various data sources is provided by the ‘data source editor’ 36 of FIG. 2 allowing completed models to be parameterized and validated against available data. The ‘variable editor’ 25 of FIG. 2 provides an interface into all of the equipments, variables, and parameters to show the values, engineering units, and upper and lower bounds on the variables.

The framework enables the use of the validated models in a number of off-line and on-line applications including “what-if” analyses, engineering design, real-time simulation, inferential property prediction, data reconciliation, yield accounting, soft-sensor analysis, control applications and process optimization. The main benefit of the framework is its model-centric capability that allows a single process model to be deployed in a multiple number of applications.

The equipment of the flowsheet are represented using objects in the underlying database. These objects also provide their data via an OPC server to external systems and are also integrated into a suitable control platform such as the Industrial^{IT} architecture of the Aspect Integration Platform available as of the filing date of this U.S. patent application from the assignee of the present invention. Once the flowsheet configuration is complete in the framework, the control platform objects can be created simply using an uploader tool. Conversely, the flowsheet may also be created in the framework from the collection of selected objects in a control system using a simple tool.

The model development framework is flexible to support different solution engines such as sequential modular solvers and equation-oriented solvers. By default, it includes a solution engine 44 that is an equation-oriented simultaneous solver for differential-algebraic equation (DAE) systems. In the embodiment for the present invention described herein this solution engine is the gPROMS software, which is available as of the filing date of this U.S. patent application from Process Systems Enterprise Limited of London, England.

The results of executing various activities in the framework can be obtained in a variety of tools including some provided by Process Systems Enterprise such as gRMS, 45a (a graphical results management system), gExcelOutput 45b (results sent to spreadsheet), and gPlot 45c (results stored in files). The framework provides additional methods to view the results of activities. Preconfigured preformatted reports 46 (for example, equipment reports and measurement reports) can automatically be generated in Microsoft® Excel at the end of an execution. The results are also available via an inbuilt OPC server 44a in solution engine 44 to external systems.

The combination of the model development framework and the solution engine gives rise to a state of the art general purpose process flowsheet modeling and simulation environment. This framework is used to develop a rigorous dynamic model of the digester 14. Then based on the same model, the model-based applications are implemented. For example, periodic simulation and estimation using the model can infer the difficult to measure variables and unmeasured disturbances that enter the pulping process 10. The framework allows for extensive model reuse and simple change propagation to all applications and thus reduces the total project engineering effort.

In order to develop a dynamic process model efficiently and flexibly, a model library 24 (see FIG. 2) is firstly developed within the framework. For the kraft pulping digester process 10, a unified modeling approach for the pulp digester 14 is presented through a modularization concept to meet different configuration needs and enhance reusability of the model.

As described in connection with FIG. 1, four process unit modules, Digester Sections 14b, Screens 14c, Top Separator 14a and Bottom Scraper 14d are considered for the digester 14. The digester model can easily be configured by connecting these basic unit modules. The Digester Section module 14b is formatted based upon a nonlinear DAE model by lumping the distributed model. This allows for various levels of complexity balanced by efficiency (accuracy and size) of solution through selecting the number of the Digester Sections.

All process modules in the model library 24 are developed based upon the first-principles approach. Rigorous reaction kinetics, dynamic heat and mass balances, momentum transport equations and material and thermal diffusivities are all considered in the model equations. Thermodynamic packages are linked within the framework to provide physical property information to the model components.

Each block or process module on the flowsheet of FIGS. 4 and 4a represents an equipment or a facility such as a valve, header, or a pump. The lines connecting these blocks are the streams carrying component information such as composition, pressure, temperature, and flowrate. The unconnected blocks represent facilities to include custom defined calculations that can be used to perform user desired calculations outside the scope of the standard library models.

With the aid of the models and the framework described above, various steady state and dynamic simulations can easily be configured. Specifications can be configured based upon the physical measurements in a mill, design data corresponding to the equipment dimensions, and some empirical data. Through the modeling framework, the dynamic solution of the rigorous process model can be solved quickly and robustly. The process simulation allows various investigations supporting both process studies and engineering analysis.

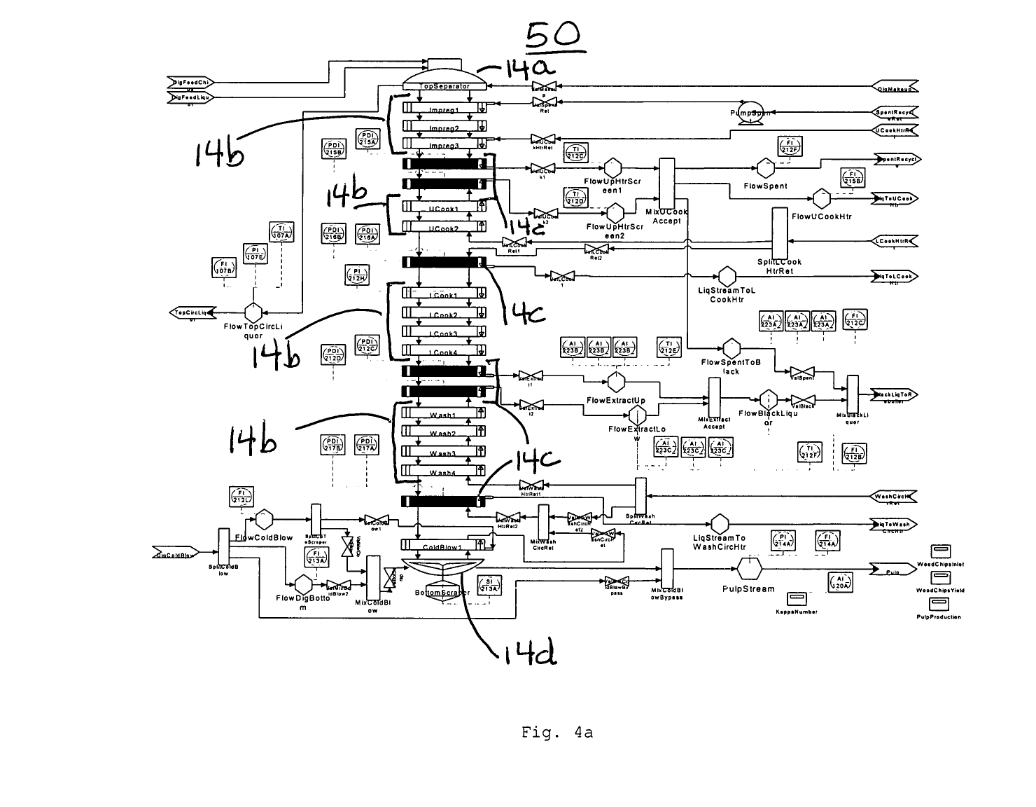

To investigate the dynamic behavior of the model, some tests were made through making step changes of several process variables. FIG. 5 shows that the Kappa number profile moves after making a 25% step increase in the rotations per minute (rpm) of the Chip screw, while keeping other variables unchanged. The Kappa numbers at all locations along the vessel increase with different gains and rise times.

The developed digester process model needs to be tuned and validated against operation data. This is important for two reasons. First, there are a number of parameters, such as kinetics parameters and heat transfer coefficients, which are unique to a particular process. Second, any model should be well proven before it gains the political acceptance required to support major engineering decisions in an operating plant. In accordance with the present invention the model parameters are updated by estimation based upon the collected operation data.

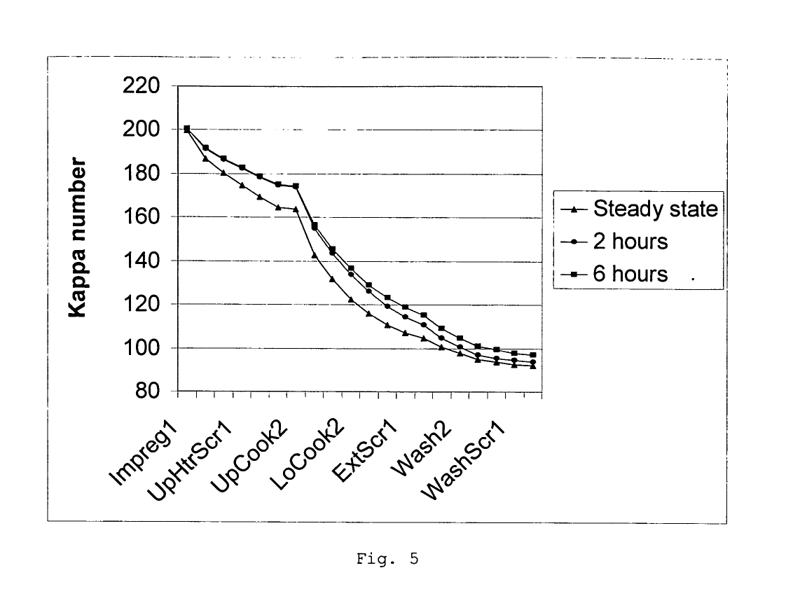

A comparison of the bottom Kappa number between model predication and measurement over a day are shown in FIG. 6. The figure shows that the model prediction results can reasonably match with actual plant measurements.

Before performing model-based applications, dynamic data reconciliation is used to reconcile process and laboratory measurements from the plant to satisfy material, energy and momentum balances. The parameter estimation described above can also be performed simultaneously with data reconciliation. The framework performs a rigorous calculation to solve the estimation and reconciliation problem and as is described above uses a solution engine such as the gPROMS software.

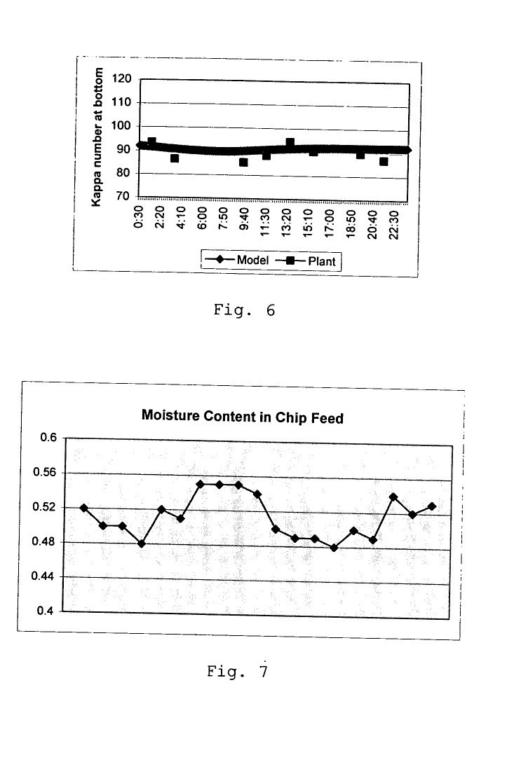

The parameter estimation and data reconciliation is setup as an optimization problem in which an attempt is made to find the values of all unknown estimated parameters (including measurement biases) such that the mathematical model will predict the values obtained from the plant operation. A maximum likelihood objective function is used to perform parameter estimation and data reconciliation. The configuration of the reconciliation problem can be carried out through the graphical estimation interface 30 of FIG. 2. Based on the well-tuned model, it is possible to infer the difficult to measure variables and unmeasured disturbances that enter the process. FIG. 7 shows the prediction of the moisture in the chip feed entering the digester.

While the framework of the present invention is described above with respect to a continuous process it should be appreciated that the same framework may also be used for batch or other types of processes.

It is to be understood that the description of the preferred embodiment(s) is (are) intended to be only illustrative, rather than exhaustive, of the present invention. Those of ordinary skill will be able to make certain additions, deletions, and/or modifications to the embodiment(s) of the disclosed subject matter without departing from the spirit of the invention or its scope, as defined by the appended claims.

1. A method associated with a process comprising:
a. building a general purpose flowsheet for said process, said general purpose flowsheet representing a model of said process;
b. generating said model of said process from said general purpose flowsheet; and
c. executing upon said model generated from said general purpose flowsheet applications selected from simulation, estimation and optimization.

2. The method of claim 1 wherein said building of said general purpose flowsheet for said process comprises:
a. selecting the solid, liquid and/or gas components of said process;
b. selecting from a library of apparatus icons the icons of the apparatus associated with said process; and
c. connecting said selected icons with streams comprised of said selected components to produce said general purpose flowsheet.

3. The method of claim 1 wherein said applications may be either on-line or off-line applications.

4. The method of claim 1 wherein said applications may be either steady state or dynamic applications.

5. The method of claim 1 wherein said process may be either a batch process, a continuous process or another type of process.

6. A computer readable medium having instructions associated with a process, said instructions comprising:
a. building a general purpose flowsheet for said process, said general purpose flowsheet representing a model of said process;
b. generating said model of said process from said general purpose flowsheet; and
c. executing applications selected from simulation, estimation or optimization upon said model generated from said general purpose flowsheet.

7. The computer readable media of claim 6 wherein said building of said general purpose flowsheet for said process comprises:
a. selecting the solid, liquid and/or gas components of said process;
b. selecting from a library of apparatus icons the icons of the apparatus associated with said process; and
c. connecting said selected icons with streams comprised of said selected components to produce said general purpose flowsheet.

8. The computer readable media of claim 6 wherein said applications may be either on-line or off-line applications.

9. The computer readable media method of claim 6 wherein said applications may be either steady state or dynamic applications.

10. The computer readable media of claim 6 wherein said process may be either a batch process, a continuous process or another type of process.

11. A method for enabling a user to build a general purpose process flowsheet whose underlying model may be used to execute applications selected from simulation, estimation and optimization comprising:
(a) enabling said user to build said general purpose process flowsheet comprising:
providing a graphical flowsheet builder;
providing a library of common equipment models;
providing selectable chemical species and their thermophysical property definitions; and
providing stream connectors to allow said user to connect models selected from said library;
(b) providing an interpreter to generate said underlying model from said general purpose flowsheet; and
(c) providing a solution engine that enables said user to use said generated underlying model in applications selected from simulation, estimation and optimization.

12. A method for enabling a user to build a general purpose process flowsheet whose underlying model may be used to execute applications selected from simulation, estimation and optimization comprising:
(a) enabling said user to build said general purpose process flowsheet comprising:
providing a graphical flowsheet builder;
providing a library of common equipment models;
providing selectable chemical species and their thermophysical property definitions; and
providing stream connectors to enable said user to connect models selected from said library;
(b) providing an interpreter to generate said underlying model from said general purpose flowsheet; and
(c) providing a solution engine that allows applications selected from simulation, estimation and optimization to be executed upon said generated underlying model.

13. An apparatus for building a general purpose flowsheet having an underlying model for a process comprising:
a) a library of selectable common equipment models;
b) a repository of selectable chemical species and their thermophysical property definitions;
c) a flowsheet editor for selecting one or more of said selectable common equipment models and one or more of said selectable chemical species and thermophysical properties definitions associated with said one or more selected models and linking said one or more selected models by stream connectors to build said general purpose flowsheet;
d) an interpreter to generate said underlying model from said general purpose flowsheet; and
e) a solution engine for executing applications selected from simulation, estimation and optimization using said generated underlying model.
